(19) United States
(12) Patent Application Publication
(10) Pub. No.: US 2026/0320362 A1
(43) Pub. Date: Oct. 15, 2026

(54) METHOD, COMPUTER DEVICE, AND COMPUTER PROGRAM FOR NETWORK QUANTIZATION USING ELEMENT-WISE DIVISION-BASED ROUNDING

(71) Applicant: NAVER Cloud Corp., Seongnam-si (KR)

(72) Inventors: Jung Hyun LEE, Seongnam-si (KR); Jeonghoon KIM, Seongnam-si (KR); Se Jung KWON, Seongnam-si (KR); Dongsoo LEE, Seongnam-si (KR)

(21) Appl. No.: 19/551,225

(22) Filed: Feb. 26, 2026

Related U.S. Application Data
(63) Continuation of application No. PCT/KR2023/014495, filed on Sep. 22, 2023.

(30) Foreign Application Priority Data
Sep. 1, 2023 (KR) 10-2023-0116488

(51) Int. Cl. G06N 3/0495

(52) U.S. Cl. CPC G06N 3/0495

(57) ABSTRACT

Disclosed are a method, a computer device, and a computer program for network quantization using element-wise division-based rounding. A network quantization method may include performing, by the at least one processor, quantization by applying a learnable parameter to a pretrained weight of a neural network, and the performing of the quantization may include quantizing the pretrained weight through an element-wise division-based rounding function using the parameter.

### FIELD OF THE INVENTION

The following description relates to technology for making a deep neural network model lightweight through network quantization.

### BACKGROUND

Currently, deep neural networks have been achieving unprecedented success in various fields, including computer vision, natural language processing, and automatic voice recognition.

In particular, with the emergence of zero-shot or few-shot performance of large language models (LLM), such as the generative pre-trained transformer (ChatGPT) or GPT-4, interest in improving latency and throughput of the LLM is significantly increasing.

Network quantization technology is gaining attention as one of technologies to improve the latency and the throughput of the LLM.

As an example of network quantization technology, technology for quantizing parameters of a neural network is disclosed in Korean Patent Laid-Open Publication No. 10-2019-0043849 (published on Apr. 29, 2019).

Network quantization technology may be broadly classified into quantization-aware training (QAT) and post-training quantization (PTQ). The quantization-aware training (QAT) is a technique that performs quantization during a training process, whereas the post-training quantization (PTQ) is a technique that performs quantization after training.

The quantization-aware training (QAT) refers to a method that integrates network quantization into the training process, requiring end-to-end retraining or fine tuning for the entire training dataset. Therefore, enormous time and resources may be required to acquire a quantized neural network with competitive performance.

As the quantization-aware training (QAT) requires a lot of time and resources, making it difficult to implement in reality, there is a growing interest in post-training quantization (PTQ) that does not require the entire training dataset or end-to-end training.

### DETAILED DESCRIPTION OF THE INVENTION

### Technical Problem

Example embodiments provide quantization technology that may learn not only parameters for the quantization grid size but also a scale for each weight according to its magnitude through element-wise division-based rounding for weights when quantizing pretrained weights of a network.

### Technical Solution

According to at least one example embodiment, there is provided a network quantization method executed by a computer device, wherein the computer device includes at least one processor configured to execute computer-readable instructions included in a memory, the network quantization method includes performing, by the at least one processor, quantization by applying a learnable parameter to a pretrained weight of a neural network, and the performing of the quantization includes quantizing the pretrained weight through an element-wise division-based rounding function using the parameter.

According to an aspect, the performing of the quantization may include performing post-training quantization for each layer or each block of the network.

According to another aspect, the performing of the quantization may include updating a quantization parameter for the pretrained weight to minimize the difference between the output of the network using the pretrained weight before quantization and the output of the network using the quantized weight after quantization.

According to still another aspect, the performing of the quantization may include jointly learning a division factor corresponding to the scale for the pretrained weight according to the magnitude of the weight and the common quantization grid size of the entire layer.

According to still another aspect, the performing of the quantization may include quantizing the pretrained weight through a division-based rounding system of the following equation:

$$\hat{W} = {s}_{1} ⌊ \frac{W}{S} ⌉$$

(here, W denotes the pretrained weight, Ŵ denotes a quantized weight, s₁ denotes the common quantization grid size of the entire layer, S denotes a division factor for the pretrained weight, and └⋅┐ denotes a rounding function).

According to still another aspect, the performing of the quantization may include updating the common quantization grid size (s₁) and the division factor (S) to minimize the difference between the output of the network using the pretrained weight (W) before quantization and the output of the network using the quantized weight (Ŵ) after quantization.

According to still another aspect, the division factor (S) may be defined as the element-wise product of the common quantization grid size (s₁) and a matrix scaling (S₂) having the same shape as the pretrained weight (W).

According to still another aspect, the matrix scaling (S₂) may be complemented by at least one additional vector that considers a channel statistical change according to a layer type.

According to still another aspect, the matrix scaling (S₂) may be complemented by an additional vector (S₃) for an output channel in the case of a linear layer, and may be complemented by the additional vector (s₃) for the output channel and an additional vector (s₄) for an input channel in the case of two-dimensional (2D) convolution.

According to still another aspect, the performing of the quantization may include performing weight quantization of a large language model (LLM) using the element-wise-division based rounding function.

Provided is a computer program stored in a computer-readable recording medium for executing the network quantization method on a computer.

There is provided a computer device including at least one processor configured to execute computer-readable instructions included in a memory, wherein the at least one processor is configured to process a process of performing quantization by applying a learnable parameter to a pretrained weight of a neural network, and to quantize the pretrained weight through an element-wise division-based rounding function using the parameter.

### Advantageous Effects of Invention

According to example embodiments, when quantizing pretrained weights of a network, large weights (i.e., important weights) may be more flexibly quantized by learning not only parameters for the quantization grid size but also a scale for each weight according to its magnitude through element-wise division-based rounding for weights, thereby significantly improving the performance after quantization, and particularly, restoring a model to a level close to its performance before quantization.

### BRIEF DESCRIPTION OF THE DRAWINGS

FIG. 1 is a block diagram illustrating an example of an internal configuration of a computer device according to at least one example embodiment;

FIG. 2 is a flowchart illustrating an example of a network quantization method that may be performed by a computer device according to at least one example embodiment;

FIG. 3 illustrates an example of describing an element-wise division-based rounding process for a weight according to at least one example embodiment;

FIG. 4 illustrates an example of describing a learnable rounding function according to at least one example embodiment;

FIG. 5 illustrates an example of describing a division factor for a weight according to at least one example embodiment;

FIG. 6 illustrates an example of describing a search space according to element-wise division-based rounding for a weight according to at least one example embodiment;

FIGS. 7 and 8 are graphs showing weight update results according to quantization using element-wise division-based rounding according to at least one example embodiment; and

FIGS. 9 and 10 are graphs showing grid shift results according to quantization using element-wise division-based rounding according to at least one example embodiment.

### BEST MODE FOR CARRYING OUT THE INVENTION

Hereinafter, example embodiments will be described in detail with reference to the accompanying drawings.

The example embodiments relate to technology for making a deep neural network model lightweight through network quantization.

The example embodiments including disclosures in detail set forth herein may perform network quantization using element-wise division-based learnable rounding.

A network quantization device according to example embodiments may be implemented by at least one computer device, and a network quantization method according to example embodiments may be performed through at least one computer device included in the network quantization device. Here, a computer program according to an example embodiment may be installed and executed on the computer device, and the computer device may perform the network quantization method according to example embodiments under control of the executed computer program. The aforementioned computer program may be stored in a computer-readable storage medium to execute the network quantization method on a computer in conjunction with the computer device.

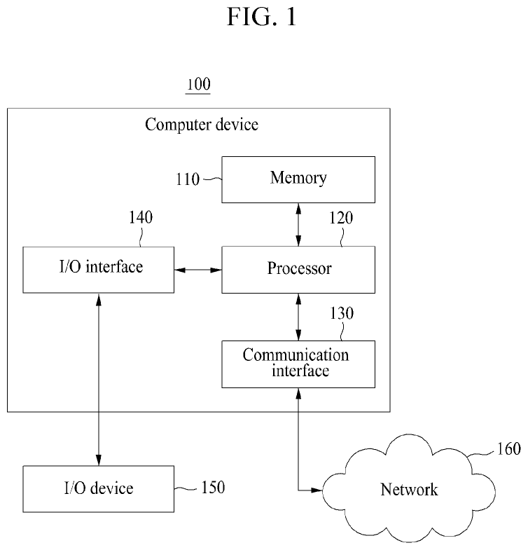

FIG. 1 is a block diagram illustrating an example of a computer device according to at least one example embodiment. For example, a network quantization device according to in example embodiments may be implemented by the computer device 100 illustrated in FIG. 1.

Referring to FIG. 1, the computer device 100 may include a memory 110, a processor 120, a communication interface 130, and an input/output (I/O) interface 140 as components to execute a network quantization method according to example embodiments.

The memory 110 may include a permanent mass storage device, such as random access memory (RAM), read only memory (ROM), and disk drive, as computer-readable recording media. Here, the permanent mass storage device, such as ROM and disk drive, may be included in the computer device 100 as a separate permanent storage device, separate from the memory 110. Also, an operating system (OS) and at least one program code may be stored in the memory 110. Such software components may be loaded to the memory 110 from computer-readable recording media separate from the memory 110. Such separate computer-readable recording media may include computer-readable recording media, such as floppy drive, disc, tape, DVD/CD-ROM drive, and memory card. In another example embodiment, software components may be loaded to the memory 110 through the communication interface 130 rather than the computer-readable recording media. For example, the software components may be loaded to the memory 110 of the computer device 100 based on a computer program installed by files received through a network 160.

The processor 120 may be configured to process instructions of a computer program by performing basic arithmetic operations, logic operations, and I/O operations. The instructions may be provided from the memory 110 or the communication interface 130 to the processor 120. For example, the processor 120 may be configured to execute instructions received according to a program code stored in a recording device such as the memory 110.

The communication interface 130 may provide a function for communication between the computer device 100 and another device through the network 160. For example, a request or a command created by the processor 120 of the computer device 100 according to a program code stored in a storage device, such as the memory 110, data, and a file may be transmitted to other devices through the network 160 under the control of the communication interface 130. Inversely, a signal or a command, data, a file, etc., from another device may be received by the computer device 100 through the network 160 and the communication interface 130 of the computer device 100. A signal or a command, data, etc., received through the communication interface 130 may be transmitted to the processor 120 or the memory 110, and a file and the like may be stored in storage media (above-described permanent storage device) further includable in the computer device 100.

A communication scheme is not limited, and may also include a near field wired/wireless communication scheme between devices as well as a communication scheme that utilizes a communication network (e.g., mobile communication network, wired Internet, wireless Internet, broadcast network) that may be included in the network 160. For example, the network 160 may include at least one of networks that include a personal area network (PAN), a local area network (LAN), a campus area network (CAN), a metropolitan area network (MAN), a wide area network (WAN), a broadband network (BBN), and the Internet. Also, the network 160 may include at least one of network topologies that include a bus network, a star network, a ring network, a mesh network, a star-bus network, and a tree or hierarchical network, but is not limited thereto.

The I/O interface 140 may be a device for interfacing with the I/O device 150. For example, an input device may include a device, such as a microphone, a keyboard, a camera, and a mouse, and an output device may include a device, such as a display and a speaker. As another example, the I/O interface 140 may be a method for interfacing with a device in which functions for input and output are integrated into one, such as a touchscreen. The I/O device 150 may be configured as a single device with the computer device 100.

Also, in other example embodiments, the computer device 100 may include greater or smaller number of components than the components of FIG. 1. However, there is no need to clearly illustrate the most conventional components. For example, the computer device 100 may be implemented to include at least a portion of the I/O device 150, or may further include other components, such as a transceiver, a camera, various sensors, and a database.

Hereinafter, specific example embodiments of network quantization technology using element-wise division-based rounding are described.

Currently, techniques have emerged to quantize models for various tasks, such as computer vision, natural language understanding, and natural language generation, without (re) training. Outlier channel splitting duplicates a channel associated with outliers and then splits the outliers of the channel in half. While this outlier channel splitting technique explicitly resolves outliers, accuracy significantly drops when a weight and activation are quantized to low bits. As a single alternative solution, a bit-split technique that optimizes an integer by splitting the integer into multiple bits is being utilized. The performance of the bit-split technique is similar to that of a full-precision model at low bit settings, but is not effective in a specific architecture such as MobileNetV2.

To overcome the limitations of the existing technology, a weight rounding mechanism called AdaRound may be utilized, and the rounding technique, AdaRound, relates to minimizing the mean squared error between the output of the full precision layer and the output of the quantized layer. In addition, there are techniques, such as block-by-block reconstruction technique (called ‘BRECQ’) and technique that randomly drops activation quantization to induce the activation quantization to synchronize with weight quantization (‘QDrop’ technique) during post-training quantization (PTQ) reconstruction, in order to consider cross-layer dependence along with the probability of quantizing MobileNetV2 into 4 bits. Both BRECQ and QDrop are based on AdaRound that rounds a maximum weight only up or down with the fixed quantization grid size.

In the early study, post-training quantization (PTQ) is performed to a value closest to rounding by minimizing a quantization error in the parameter space. This approach leads to the severe degradation in performance, and the loss degradation due to quantization may be approximated by the second error of Taylor expansion by considering a quantized weight as a perturbation weight. Therefore, reconstructing the output of a layer or a block may be considered equivalent to minimizing the approximation of the loss degradation due to quantization.

In the recent research, techniques have been proposed to reconstruct the output of a layer or a block by training through a new weight rounding system as an effort to preserve the performance of the full-precision model even after post-training quantization (PTQ). However, the rounding system designed in the existing research relates to simply adaptively rounding or quantizing pretrained weights through element-wise addition.

The example embodiment applies a post-training weight quantization method based on an element-wise division approach (‘FlexRound’), instead of an element-wise addition approach. FlexRound provides a new approach to post-training quantization (PTQ) by jointly learning division factors for pretrained weights and the common quantization grid size. Thanks to mutual rules of derivates derived by element-wise division, FlexRound may inherently utilize the pretrained weights when updating the individual scale for the pretrained weights. In particular, FlexRound may explore the relatively wider range of discrete values when quantizing large-scale pretrained weights. This is because the magnitude of weights may be interpreted as their relative importance within the network. To maintain the performance of the pretrained model even after quantization, a weight with a large absolute value may be quantized through comparison to a weight with a small absolute value in consideration that a larger weight has a greater impact on the network performance. That is, an important weight may be quantized not only into two closest discrete values but also into one of more distant discrete values. Therefore, FlexRound may flexibly quantize pretrained weights according to their own magnitude, so the performance may be improved.

That is, the example embodiment may apply FlexRound, a rounding system based on the element-wise division principle, to jointly learn not only the separate scale for all pretrained weights but also the common quantization grid size across groups (e.g., layers, channels, blocks, etc.). FlexRound, the rounding system based on the element-wise division, may more flexibly quantize large pretrained weights (i.e., important weights) in consideration of the magnitude of the pretrained weights when updating the corresponding scale.

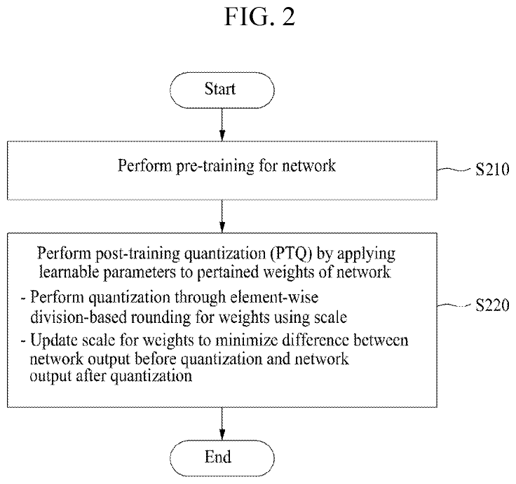

FIG. 2 is a flowchart illustrating an example of a network quantization method that may be performed by a computer device according to at least one example embodiment.

The computer device 100 according to the example embodiment may provide a desired service to a client through connection to a dedicated application installed on the client or a website/mobile site related to the computer device 100. A computer-implemented network quantization device may be configured in the computer device 100. For example, the network quantization device may be implemented in the form of an independently operating program, or may be configured in an in-app form of a specific application and implemented to be operable on the specific application.

The processor 120 of the computer device 100 may be implemented as a component for performing the following network quantization method. Depending on example embodiments, the components of the processor 120 may be selectively included in or excluded from the processor 120. Also, depending on example embodiments, the components of the processor 120 may be separated or merged for functional representation of the processor 120.

The processor 120 and the components of the processor 120 may control the computer device 100 to perform operations included in the following network quantization method. For example, the processor 120 and the components of the processor 120 may be implemented to execute an instruction according to a code of at least one program and a code of an operating system (OS) included in the memory 110.

Here, the components of the processor 120 may be representations of different functions performed by the processor 120 according to an instruction provided from a program code stored in the computer device 100.

The processor 120 may read a necessary instruction from the memory 110 to which instructions related to control of the computer device 100 are loaded. In this case, the read instruction may include an instruction for controlling the processor 120 to execute the following operations.

Operations included in the network quantization method described below may be performed in order different from the illustrated order, and some of the operations may be omitted, or an additional process may be further included.

Referring to FIG. 2, in operation S210, the processor 120 may perform pretraining for a corresponding network with respect to a deep neural network utilized for various models, such as an LLM. In the example embodiment, pretraining of the network may be performed before quantization to apply post-training quantization (PTQ).

In operation S220, the processor 120 may perform post-training quantization (PTQ) by performing quantization by applying learnable parameters to pretrained weights of a network. In particular, the processor 120 may perform quantization through element-wise division-based rounding using separate scale for all the pretrained weights, and may update weight parameters for (common quantization grid size and division factor) to minimize the difference between the network output before quantization and the network output after quantization. That is, the example embodiment may perform post-training quantization (PTQ) element-wise division-based rounding for weights, and may learn and reflect the scale (division coefficient) for the pretrained weights and the common quantization grid size of the entire layer during a quantization process.

Herein, specific example embodiments of element-wise division-based learnable rounding technology for post-training quantization (PTQ) are described.

### Notation

A scalar, a vector, and a matrix (or tensor) are represented by lowercase, bold lowercase, and uppercase letters, respectively, for example, s, s, and S. Ŵ represents the quantized counterpart of W. Input to a 2D convolution or a linear layer is represented as X if all previous layers are intact, and is expressed as \tilde{X} if all previous layers are quantized. Entries of matrix A are represented as A_{(i,j)}, and entries of 4-dimensional tensor A are represented as A_{(i,j,k,l)}. Similar to a broadcasting process of Python NumPy, ⊙ represents the element-wise product and/represents element-wise division. Also, └⋅┐ denotes a rounding function, and └⋅┘ denotes a floor function). ∥⋅∥F denotes a Frobenius norm.

### Background of Post-Training Quantization (PTQ)

The post-training quantization (PTQ) approach quantizes the pretrained weight W to be

$$\hat{W} = {s}_{1} ⌊ \frac{W}{{s}_{1}} ⌉$$

through rounding. Here, the quantization grid size s₁∈R_{>0} is set to minimize

$${‖ W - \hat{W} ‖}_{F}^{2}$$

However, minimizing a quantization error in the parameter space is not equal to the final task loss. It may be minimized for each layer or each block in relation to continuous variable V with a small amount of data in that the loss degradation due to quantization may be approximated to the second-order form of the network output and Hessian matrix

$${( WX - \hat{W} \tilde{X} ‖}_{F}^{2} ) .$$

Here, Ŵ represents one of

$${s}_{1} ( ⌊ \frac{W}{{s}_{1}} ⌋ + h ( V ) )$$

and

$${s}_{1} ⌊ \frac{W + V}{{s}_{1}} ⌉$$

having a specific function h(⋅). However, all the above-described rounding mechanisms are based on element-wise addition.

### FlexRound

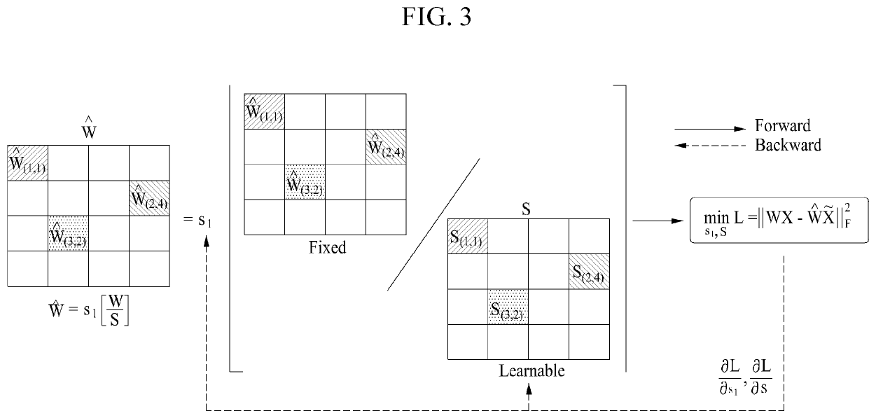

FIG. 3 is an example of describing an element-wise division-based rounding process for a weight in at least one example embodiment. FIG. 3 illustrates the element-wise division-based rounding process in tensor-specific post-training quantization (PTQ) reconstruction.

Unlike the element-wise addition-based approach, the example embodiment applies element-wise division to quantize pretrained weights. The weight rounding system based on element-wise division may be defined as Equation 1.

$$\hat{W} = {s}_{1} ⌊ \frac{W}{S} ⌉ \qquad [ Equation 1 ]$$

S represents the division factor for W as the scale identical in shape to the pretrained weight W. s₁ denotes the common quantization grid size of the entire layer. All entries of S and s₁ are positive and learnable. S and s₁ are updated in a direction that minimizes the reconstruction error L,

$${‖ WX - \hat{W} \tilde{X} ‖}_{F}^{2} .$$

Equation 1 refers to the basic formula of FlexRound, indicating that it supports tensor-specific uniform post-training quantization (PTQ). FlexRound may adopt per-channel weight quantization by simply replacing the scalar s₁ with the vector S₁, but the tensor-specific uniform post-training quantization (PTQ) through FlexRound may be sufficient to achieve the performance of the full-precision model. Therefore, the focus is on reconstruction of tensor-specific uniform post-training quantization (PTQ).

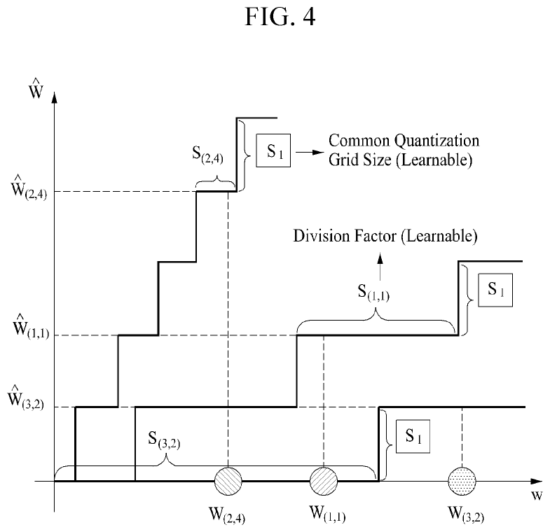

FIG. 4 is an example of describing a learnable rounding function in at least one example embodiment. In the case of the rounding function using learnable parameters S and s₁, pretrained weights may be flexibly quantized as Ŵ_{(2,4)}<Ŵ_{(3,2)}, or using different S_{(i,j)}.

The method of designing S is as follows. Initially, S may be formulated as S=s₁⊙S₂. Here, S₂ is the matrix or tensor-scaled W identical in shape to W, and all elements of S₂ are positive and learnable. If S=s₁⊙S₂, the performance is better compared to the weight rounding system based on element-wise addition in per-unit uniform post-training quantization (PTQ) configuration. However, to further improve the performance of the new weight rounding system based on element-wise division, S₂ may be complemented as follows. In the case of a linear layer W∈R^{C}^{ₒᵤₜ}^{×C}^{ᵢₙ}, S₂ may be complemented using the learnable additional tensor

$${s}_{3} ∈ {R}_{> 0}^{{C}_{out} \times 1} .$$

Since statistics of the output channel may significantly vary, the change in output channel statistics may be considered by complementing S₂ using s₃. That is, s₃ is an additional vector that supports S₂ to describe the statistical change of the output channel in W. Depending on example embodiments, for 2D convolution W∈^{C}^{ₒᵤₜ}^{×C}^{ᵢₙ}^{×H×W}, S₂ may be complemented using two learnable additional tensors, that is, an additional tensor for an output channel,

$${s}_{3} ∈ {R}_{> 0}^{{C}_{out} \times 1 \times 1 \times 1} ,$$

and an additional tensor for an input channel,

$${s}_{4} ∈ {R}_{> 0}^{1 \times {C}_{in} \times 1 \times 1} .$$

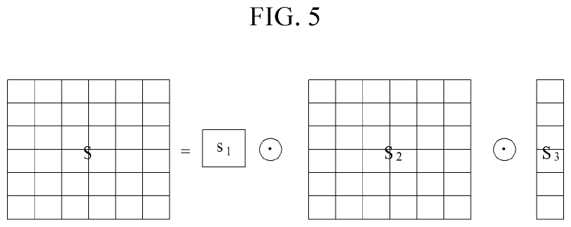

Therefore, S is complemented using at least one additional vector depending on the layer type, and in the case of the linear layer, S may be formulated as s₁⊙S₂⊙^{s}^{₃} as illustrated in FIG. 5, and in the case of 2D convolution, S may be formulated as s₁⊙s₂⊙^{s}^{₃}⊙^{s}^{₄} depending on example embodiments.

$$\hat{W} \{ \begin{matrix}{s}_{1} ⌊ \frac{W}{{s}_{1} ⊙ {S}_{2} ⊙ {s}_{3}} ⌉ & for a linear layer \\ {s}_{1} ⌊ \frac{W}{{s}_{1} ⊙ {S}_{2} ⊙ {s}_{3} ⊙ {s}_{4}} ⌉ & for a 2 D convolution\end{matrix} \qquad [ Equation 2 ]$$

Equation 2 may be considered as the final formula of FlexRound. Here, all elements of S₂, ^{s}^{₃}, and ^{s}^{₄} are initialized to 1 to facilitate training in a general rounding method, that is,

$${s}_{1} ⌊ \frac{W}{{s}_{1}} ⌉ .$$

All parameters (^{s}^{₁}, S₂, ^{s}^{₃}, and ^{s}^{₄}) are updated to minimize

$${‖ WX - \hat{W} \tilde{X} ‖}_{F}^{2}$$

under the constraint that all entries of ^{s}^{₁}, S₂, ^{s}^{₃}, and ^{s}^{₄} are positive.

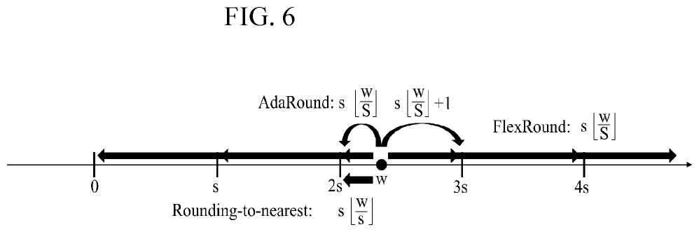

FIG. 6 is an example of describing the search space based on element-wise division-based rounding for weights in at least one example embodiment. As illustrated in FIG. 6, Rounding-to-Nearest (RTN) rounds a weight to a nearest value, or AdaRound, one of post-training quantization (PTQ) methods, rounds a weight only up or down according to the element-wise addition-based rounding system, whereas FlexRound according to the present invention may more flexibly change a weight within the wider search space through the element-wise division-based rounding system.

In Equation 2, the element-wise division provides the purpose similar to the element-wise addition that generates a more effective rounding system than rounding-to-nearest. By implementing a new rounding policy through the element-wise division, ^{s}^{₁}, S₂, ^{s}^{₃} and ^{s}^{₄} may be all learned. Through this, FlexRound may learn the common quantization grid size (i.e., ^{s}^{₁}) along with a rounding process (e.g., S₂⊙^{s}^{₃} or S₂⊙^{s}^{₃}⊙^{s}^{₄}). Also, through mutual rules of derivatives derived by the element-wise division, FlexRound may utilize the pretrained weight when learning the corresponding scale.

Let L be the reconstruction error that represents the difference between the network output before quantization and the network output after quantization and S′ be the matrix (or tensor) that scales the pretrained weight W, that is, S′=S₂⊙^{s}^{₃} (or S₂⊙^{s}^{₃}⊙^{s}^{₄}) in Equation 2. When using a straight-through estimator (STE), the gradient of L for the entry of S′,

$$\frac{\partial L}{\partial {S}_{( i , j )}^{′}} ( or \frac{\partial L}{\partial {S}_{( i , j , k , l )}^{′}} ) ,$$

is proportional to the pretrained weight W_{(i,j)} (or W_{(i,j,k,l)}).

The proposition indicates that, in the case of the linear layer, the element S′_{(i,j)} is influenced by W_{(i,j)}, so

$${\overline{W}}_{( i , j )} = ⌊ \frac{{W}_{( i , j )}}{{s}_{1} ⊙ {S}_{( i , j )}^{′}} ⌉$$

may be updated, and may also be influenced by W_{(i,j)}. That is, according to an increase in the magnitude of the pretrained weight W_{(i,j)}, the probability that W_{(i,j)} may be further updated during the post-training quantization (PTQ) reconstruction may increase. The magnitude of the weight may be regarded as the scale for measuring the weight importance for pruning an unimportant weight. As a result, a weight with a larger value plays an important role than a weight with a smaller value. To reduce the performance difference between a pretrained model with full prevision and a quantized version, the likelihood of quantization into one of two quantization grids further away than a smaller grid in addition to the two closest quantization grids may increase, so large-scale pretrained weights (potentially important pretrained weights) may be quantized. This may be equally applied to 2D convolution.

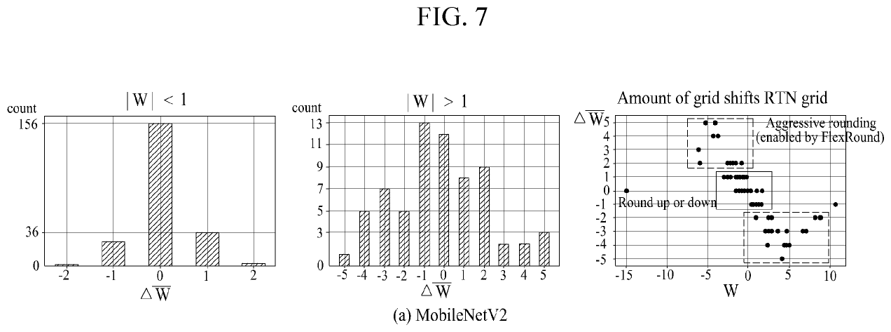

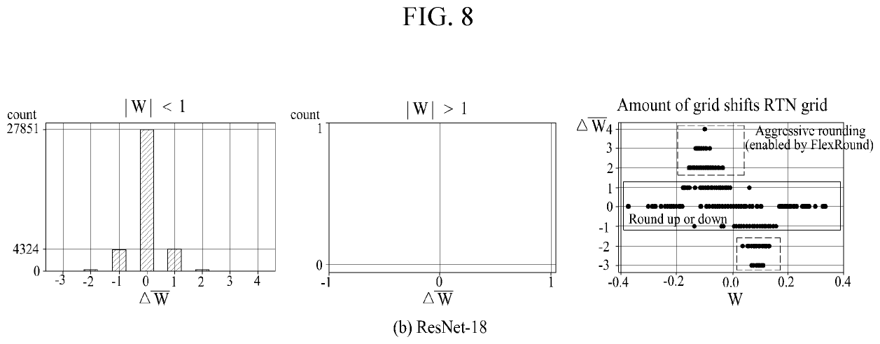

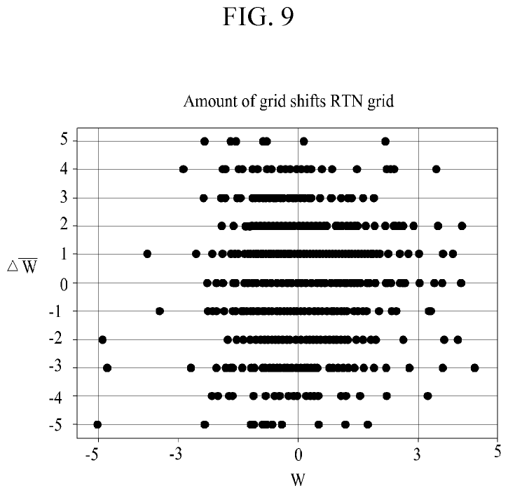

FIGS. 7 and 8 illustrate the weight update result according to quantization using element-wise division-based rounding in at least one example embodiment. In first blocks of MobileNetV2 (FIG. 7) and ResNet-18 (FIG. 8), the weight update through FlexRound of first 2D convolution quantizes pretrained weights into 4bits through FlexRound, and then the activation is maintained at the full precision.

FIGS. 7 and 8 show the quantity of weight update through FlexRound for MobileNetV2 and ResNet-18. In FIGS. 7 and 8, histograms on the left and at the center show the change in grouped for W̅_{(i,j,k,l)} small pretrained weights (|W|<1, left) and large pretrained weights (|W|>1, center). The scatter plots on the right show the grid shifts that may be acquired from RTN. It can be seen that MobileNetV2 and ResNet-18 are distinctively quantized due to FlexRound. For example, in the case of MobileNetV2, when an absolute value of W_{(i,j,k,l)} is greater than 1, the change in W̅_{(i,j,k,l)} acquired by minimizing L is more aggressive (i.e., rounding may deviate from ascent of one step or descent of one step). That is, FlexRound more flexibly quantizes large-scale pretrained weights as indicated in the dashed box of FIG. 7. In the first 2D convolution of the first block of MobileNetV2, the amount of aggressively rounded weights is about 12.8% of the total. However, in the case of ResNet-18, there are no pretrained weights with the magnitude greater than 1. Therefore, as illustrated in FIG. 8, most pretrained weights are rounded up or down (e.g., in first 2D convolution of first block of ResNet-18, only about 1.5% of weights are aggressively rounded).

When FlexRound updates the corresponding scale, the magnitude of pretrained weights may be considered, and large-scale pretrained weights are more likely to be quantized with greater flexibility compared to small-scaled weights.

$$\frac{\partial L}{\partial {S}_{( i , j )}^{′}}$$

is directly proportional to

$$\vert {W}_{( i , j )} \frac{\partial L}{\partial {\hat{W}}_{( i , j )}} \vert .$$

No matter how large the magnitude of W_{(i,j)} is, if

$$\vert \frac{\partial L}{\partial {\hat{W}}_{( i , j )}} \vert$$

is close to 0,

$$\frac{\partial L}{\partial {S}_{( i , j )}^{′}}$$

also becomes 0. In this sense, large-scale pretrained weights may be quantized into grids that may be acquired from RTN. When

$$\vert \frac{\partial L}{\partial {\hat{W}}_{( i , j )}} \vert$$

is (significantly) larger than 0, large-scale pretrained weights may be quantized from the two closest grids to a farthest grid. For example, while the magnitude of pretrained weights influences the corresponding scale update of FlexRound, it does not necessarily indicate that large weights need to be quantized more flexibly than smaller weights.

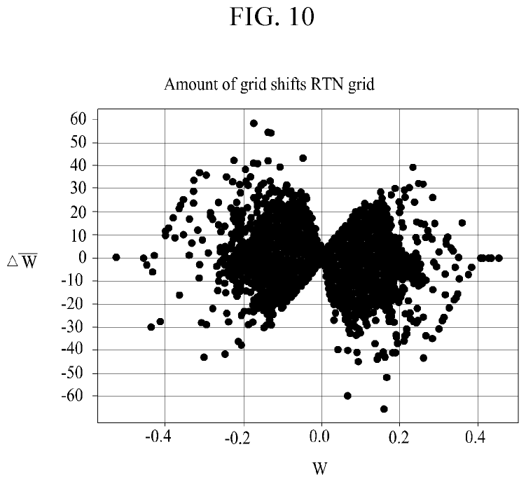

FlexRound may more flexibly quantize weights as the bit width increases. Comparing right-hand graphs of FIGS. 7 and 8 with the graph of FIG. 10, FlexRound may provide more grid shifts than grids that may be acquired from RTN since the high bit width is used. Unlike AdaRound that rounds weights only up or down regardless of the number of bits used, FlexRound enables more flexible weight quantization as the bit width increases, so may be more suitable for quantizing a model that requires the high bit width than AdaRound (e.g., LLM).

According to example embodiments, when quantizing pretrained weights of the network, large weights may be more flexibly quantized by learning not only parameters for the quantization grid size but also a scale for each weight according to its magnitude through element-wise division-based rounding for weights. As a result, FlexRound using the element-wise division-based rounding technique may operate better than the existing technology in various types of tasks, including image classification, natural language understanding, and natural language generation, for various models ranging from small models to large models such as ResNet, MobileNet, BERT, GPT-Neo, OPT, and LLaMA. In particular, in the case of the LLM, the existing technology suffers from performance degradation after quantization. However, FlexRound according to the present invention may reduce the difference in performance before quantization and after quantization, and may quantize activation of the LLM to 8 bits without any assumption for activation outliers, thereby simultaneously improving latency and throughput of the LLM.

The apparatuses described herein may be implemented using hardware components, software components, and/or the combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, or computer storage medium or device to provide instructions or data to or to be interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions executable through various computer methods. Here, the media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

### MODE FOR CARRYING OUT THE INVENTION

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

1. A network quantization method executed by a computer device, wherein the computer device comprises at least one processor configured to execute computer-readable instructions included in a memory, the network quantization method comprising:
performing, by the at least one processor, quantization by applying a learnable parameter to a pretrained weight of a neural network, and
the performing of the quantization including quantizing the pretrained weight through an element-wise division-based rounding function using the parameter.

2. The network quantization method of claim 1, wherein the performing of the quantization comprises performing post-training quantization for each layer or each block of the network.

3. The network quantization method of claim 1, wherein the performing of the quantization comprises updating a quantization parameter for the pretrained weight to minimize the difference between the output of the network using the pretrained weight before quantization and the output of the network using the quantized weight after quantization.

4. The network quantization method of claim 1, wherein the performing of the quantization comprises jointly learning a division factor corresponding to the scale for the pretrained weight according to the magnitude of the weight and the common quantization grid size of the entire layer.

5. The network quantization method of claim 1, wherein the performing of the quantization comprises quantizing the pretrained weight through a division-based rounding system of the following equation:
$$\hat{W} = {s}_{1} ⌊ \frac{W}{S} ⌉$$
where W denotes the pretrained weight, Ŵ denotes a quantized weight, s₁ denotes the common quantization grid size of the entire layer, S denotes a division factor for the pretrained weight, and └⋅┐ denotes a rounding function.

6. The network quantization method of claim 5, wherein the performing of the quantization comprises updating the common quantization grid size (s1) and the division factor (S) to minimize the difference between the output of the network using the pretrained weight (W) before quantization and the output of the network using the quantized weight (Ŵ) after quantization.

7. The network quantization method of claim 5, wherein the division factor (S) is defined as the element-wise product of the common quantization grid size (s1) and a matrix scaling (S2) having the same shape as the pretrained weight (W).

8. The network quantization method of claim 7, wherein the matrix scaling (S2) is complemented by at least one additional vector that considers a channel statistical change according to a layer type.

9. The network quantization method of claim 7, wherein the matrix scaling (S2) is complemented by an additional vector (s3) for an output channel in the case of a linear layer, and is complemented by the additional vector (s3) for the output channel and an additional vector (s4) for an input channel in the case of two-dimensional (2D) convolution.

10. The network quantization method of claim 1, wherein the performing of the quantization comprises performing weight quantization of a large language model (LLM) using the element-wise-division based rounding function.

11. A non-transitory computer-readable recording medium storing a program for executing the network quantization method according to claim 1 on a computer.

12. A computer device comprising:
at least one processor configured to execute computer-readable instructions included in a memory,
wherein the at least one processor is configured to process a process of performing quantization by applying a learnable parameter to a pretrained weight of a neural network, and to quantizing the pretrained weight through an element-wise division-based rounding function using the parameter.

13. The computer device of claim 12, wherein the at least one processor is configured to perform post-training quantization for each layer or each block of the network.

14. The computer device of claim 12, wherein the at least one processor is configured to update a quantization parameter for the pretrained weight to minimize the difference between the output of the network using the pretrained weight before quantization and the output of the network using the quantized weight after quantization.

15. The computer device of claim 12, wherein the at least one processor is configured to jointly learn a division factor corresponding to the scale for the pretrained weight according to the magnitude of the weight and the common quantization grid size of the entire layer.

16. The computer device of claim 12, wherein the at least one processor is configured to quantize the pretrained weight through a division-based rounding system of the following equation.
$$\hat{W} = {s}_{1} ⌊ \frac{W}{S} ⌉$$
where W denotes the pretrained weight, Ŵ denotes a quantized weight, s1 denotes the common quantization grid size of the entire layer, S denotes a division factor for the pretrained weight, and denotes a rounding function.

17. The computer device of claim 16, wherein the at least one processor is configured to update the common quantization grid size (s1) and the division factor (S) to minimize the difference between the output of the network using the pretrained weight (W) before quantization and the output of the network using the quantized weight (Ŵ) after quantization.

18. The computer device of claim 16, wherein the division factor (S) is defined as the element-wise product of the common quantization grid size (s1) and a matrix scaling (S2) having the same shape as the pretrained weight (W).

19. The computer device of claim 18, wherein the matrix scaling (S2) is complemented by at least one additional vector that considers a channel statistical change according to a layer type.

20. The computer device of claim 18, wherein the matrix scaling (S2) is complemented by an additional vector (s3) for an output channel in the case of a linear layer, and is complemented by the additional vector (s3) for the output channel and an additional vector (s4) for an input channel in the case of two-dimensional (2D) convolution.
